(19) United States
(12) Patent Application Publication
(10) Pub. No.: US 2009/0154446 A1
(43) Pub. Date: Jun. 18, 2009

(54) DATA FRAME, TELEGRAM, METHOD FOR CONTROLLING AN RF-TRANSCEIVER AND MOBILE COMMUNICATION SYSTEM

(75) Inventors: Bernd Adler, Neubiberg (DE); Christian Duerdodt, Bochum (DE); Gerhard Eichiner, Munchen (DE); Stefan Herzinger, Sauerlach (DE); Rainer Koller, Linz (AT); Michael Meixner, Munich (DE); Burkhard Neurauter, Linz (AT); Thomas Puehringer, Pfarrkirchen (AT); Irene Schuster, Kronstorf (AT); Dietmar Wenzel, Munchen (DE)

Correspondence Address: ESCHWEILER & ASSOCIATES LLC, 629 EUCLID AVENUE, SUITE 1000, NATIONAL CITY BUILDING, CLEVELAND, OH, 44114, US

(73) Assignee: INFINEON TECHNOLOGIES AG, Neubiberg (DE)

(21) Appl. No.: 11/957,229

(22) Filed: Dec. 14, 2007

(51) Int. Cl. H04J 3/06; H04B 7/005

(52) U.S. Cl. 370/350; 370/310

(57) ABSTRACT

The invention is related to a data frame, particularly to a data frame configured to be received and processed by an RF-transceiver and a data frame structure. The invention is also related to a method for controlling an RF-transceiver.

### FIELD OF THE INVENTION

The present invention relates to a data frame, particularly to a data frame for being received and processed by an RF-transceiver and to a data frame structure. The invention is also related to a method for controlling an RF-transceiver.

### BACKGROUND OF THE INVENTION

Mobile communication systems and user devices are becoming increasingly complex due to user demands of transmitting and receiving a plurality of RF signals according to several and different communication standards. Such mobile communication systems may be included in mobile phones, PDAs, Laptops, Palmtops, mobile game consoles and the like. Communication standards may include the GSM mobile communication standard, the GSM/EDGE mobile communication standard, the Bluetooth, the communication standard W-CDMA mobile communication standard sometimes referred to UMTS, which are part of standard group called 3GPP standard. Next generation standards like HSDPA or Geran evolution may be used as well. Mobile communication standards may also include a wireless LAN standard like for instance Hyper LAN, WiMax or ETSI 802.11a, 11b, 11c, 11g and 11h standards. A mobile communication system may be adapted to transmit and receive signals according to at least one of those communication standards. In addition, users may prefer a smaller size of these mobile communication devices for convenience purposes, which require a highly integrated circuitry.

### SUMMARY OF THE INVENTION

A communication system may comprise different devices, units and elements for signal generation, signal transmission and signal reception. For instance, very often user side signal processing and base band signal generation may be combined in a single base band device integrated on a semiconductor chip. Accordingly, RF signal transmission, RF signal reception and some analog pre-processing of received signals can be combined in an RF-transceiver device separated from a base band device. Such RF-transceiver device may comprise one or more signal paths for receiving and transmitting RF signals according to one or more mobile communication standards. For example, an RF-transceiver device may comprise a first transmitting path for transmitting signals according to a first mobile communication standard and a second transmitting path for transmitting signals according to a second mobile communication standard. Those signal paths can be completely separated or may comprise shared components. The RF-transceiver device may be integrated in a semiconductor chip.

In one embodiment, the invention may improve the communication between a base band device and an RF-transceiver device by relaxing the requirement of timely accurate messages transmitted between the base band device and the RF-transceiver device.

In one embodiment a data frame is provided for being received and processed by an RF-transceiver. The RF-transceiver comprises a plurality of selectable operating states, and some of the plurality of operating states are configured to transmit and receive signals according to at least one mobile communication standard. In one embodiment, the data frame comprises a command field and a parameter field. The command field comprises a command specifying a transition from a first operating state to at least one second subsequent operating state out of the plurality of selectable operating states. The parameter field comprises at least a plurality of parameters defining the at least one second subsequent operating state.

In another embodiment a data frame structure according to the DigRF DUAL-MODE 2.5G/3G BASE BAND/RFIC INTERFACE STANDARD comprises a payload field having a first portion and a second portion. The first portion comprises a macrocode command suitable to be processed in an RF-transceiver device. The command may specify at least a first operation mode out of a plurality of operation modes of the RF-transceiver device. The second portion comprises a plurality of parameters wherein at least one first parameter of the plurality of parameters defines a duration for the at least first operation mode and at least a second parameter of the plurality of parameters defines a condition of the RF-transceiver device to be set after expiration of the duration.

In a further embodiment, a method for controlling an RF-transceiver comprises transmitting a control packet, wherein the control packet comprises a command field and a parameter field. The command field comprises a command specifying an operating state of the RF-transceiver or a transition between a first operating state and at least one second operating state of the RF-transceiver. The parameter field of the control packet comprises a plurality of parameters defining the operating state or the at least one second operating state. The control packet is received by the RF-transceiver and the command within the command field and the plurality of parameters within the parameter field are processed. An initializing packet is also transmitted, and is received by the RF-transceiver. Finally, an operating state is selected as specified in the control packet or the RF-transceiver is switched from the first operating state to the at least subsequent second operating state as specified in the control packet in response to the initializing packet.

### BRIEF DESCRIPTION OF THE DRAWINGS

In the following different aspects and embodiments will be explained in greater detail hereafter with reference to the accompanying drawings in which

FIG. 1A illustrates a logical structure of a mobile communication system having a base band device and an RF-transceiver device according to an embodiment,

FIG. 1B shows a RF-transceiver device for transmitting and receiving a plurality of signals,

FIG. 2 illustrates telegram with a payload field according to the DigRF interface standard,

FIG. 3 shows a data frame having a command and parameter field according to a first embodiment,

FIG. 4 illustrates a data frame having a command and parameter field according to a second embodiment,

FIG. 5 shows a method for processing the content according to an embodiment,

FIG. 6 shows a schematic structure of a signal frame according to the GSM mobile communication standard,

FIG. 7 illustrates various examples of a GSM mobile communication frame structure having several transmitting and receiving time slots,

FIG. 8 shows a table illustrating the time slots for transmitting signals according to the examples of FIG. 7,

FIG. 9 illustrates a data frame having a command field and parameter field according to a third embodiment,

FIG. 10 illustrates a data frame having a command field and a parameter field according to a fourth embodiment,

FIG. 11 illustrates a data frame having a command field and a parameter field according to a fifth embodiment,

FIG. 12 shows an exemplary diagram illustrating the switching behavior of a RF-transceiver between various operating states according to an embodiment,

FIG. 13 shows a data frame having a command field and a parameter field according to a sixth embodiment,

FIG. 14 shows a data frame having a command field and a parameter field according to a seventh embodiment,

FIG. 15 illustrates a data frame according to an eighth embodiment,

FIG. 16 shows a portion of an RF-transceiver front-end illustrating another aspect according to an embodiment,

FIG. 17 shows a data frame according to a ninth embodiment.

### DETAILED DESCRIPTION OF THE INVENTION

In the following description, further aspects and embodiments of the present invention are disclosed. In addition, reference is made to the accompanying drawings, which form a part hereof and in which is shown by way of illustration in which the invention may be practiced. The embodiments of the drawings present a discussion in order to provide a better understanding of one or more aspects of the invention. The disclosure is not intended to limit the features or key elements of the invention to a specific embodiment. Rather, the different elements, aspects and features disclosed in the embodiments may be combined in different ways by a person skilled in the art to achieve one or more advantages of the present invention. It is to be understood that other embodiments may be utilized and structural or logical changes may be made without departing from the scope of the invention. For illustration purposes some communication standards for exchanging information and data between a base band and an RF-transceivers device are specified. These are communication standards referred to herein and not restricted to the enclosed embodiments or claimed subject matters. Other communication standards, advanced and subsequent versions of the standards mentioned herein can be also used to achieve different aspects of the present invention.

Further, some examples of data frames with this specific order in the parameter field are disclosed. The parameter order shall be considered as a non-limiting example of a parameter field in a data frame. Particularly, parameters may be replaced or re-arranged within the parameter field without departing from the scope of the invention. Like reference numerals designate corresponding similar parts.

For further illustration purposes an example of a general digital interface standard for exchanging data and information between a base band device and an RF-transceiver device is also presented. Such interface standard may be packet oriented. Particularly, the embodiments shown herein are not restricted to a specific version of an interface standard.

Further different mobile communication standards are used exemplary herein. Those standards are often referred to as 2^{nd} generation (2G), 2.5 generation (2.5G) or 3^{rd} generation standards (3G). The 3rd Generation Partnership Project (3GPP) is a collaboration between groups of telecommunications associations, to make a globally applicable third generation (3G) mobile phone system specification within the scope of the International Mobile Telecommunications-2000 project of the International Telecommunication Union (ITU). 3GPP specifications are based on evolved Global System for Mobile Communications (GSM) specifications. 3GPP standardization encompasses Radio, Core Network and Service architecture. The latest specification is available on the internet and is incorporated herein in its entirety. 3G standards may include W-CDMA, UMTS, UMTS-TDD, CDMA2000, HSPA, HSDPA and the 3GPP standards. 4^{th} generation mobile standards may include WiMax, LTE (long term evolution), WiBro, Hiperman, 802.11, HyperLan, Ultra-WCDMA and the like.

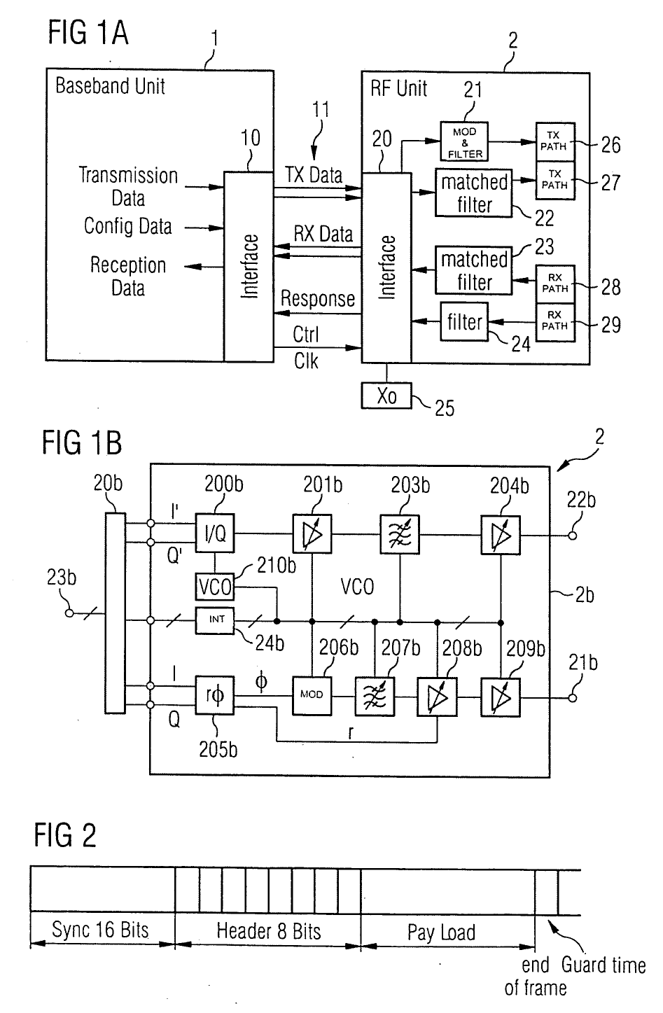

FIG. 1A illustrates a schematic view of a logical design of a communication system according to one embodiment of the invention. For each logical element shown herein, the communication system may comprise one or more integrated circuits as well as discrete elements. The integrated circuits can be arranged on a module (not shown herein) connecting the integrated circuits to each other. Some of those integrated circuits and discrete elements may be utilized to process user actions like, for example, receiving inputs from a user terminal providing data to the terminal, recording voice, pictures or even videos for a subsequent transmission.

For this purpose, the communication system may comprise a main processing device for processing user action, recording and buffering date preparing data to be transmitted and so forth. Further, the communication system may comprise a base band unit 1 integrated in a semiconductor substrate. The base band unit 1 may receive data to be transmitted from a main processing device (not shown herein) and perform a pre-processing of the received data. For instance, depending on a mobile communication standard required by a user for the data to be transmitted, the base band unit 1 may re-arrange the data into packets including any data encoding, may calculate check error redundancies, add check sums data to the generated packets and finally generate I and Q symbols out of the generated packets.

Further, the base band unit 1 comprises a digital interface 10 for communicating and exchanging data 11 with an RF-transceiver 2. The RF-transceiver 2 may be integrated in a separate semiconductor substrate. The RF-transceiver 2 also comprises a digital interface 20 connected to the digital interface 10 of the base band unit 1. The digital interface 20 receives any data transmitted by the base band unit to the RF-transceiver 2 and processes the data depending on commands sent by the base band unit 1.

The RF-transceiver 2 comprises one or more logical transmitter paths 26, 27 as well as one or more logical receiver paths 28, 29. In this embodiment, the logical transmitter path 26 is used for transmitting signals according to a second generation mobile communication standard (2G). The GSM mobile communication standard and the GSM/EDGE mobile communication standard may be considered as second generation mobile communication standards (EDGE is sometimes considered as 2.5 Generation standard). The logical transmitter path 27 is used to transmit signals according to a third generation mobile communication standard (3G), which may include the UMTS mobile communication standard, the WCDMA-standard or any WLAN standard. Those standards may also be included in the 3GPP standards. Some elements of the logical transmitter paths 26, 27 can be utilized by both paths as shared devices. For example, an I/Q-modulator, modulating I and Q signals onto a carrier signal can be used for transmitting signals according to any second mobile communication standard as well as to any of the third generation mobile communication standards.

In this embodiment, the digital interface 20 forwards data to the logical transmitter path 26 through a modulator and filter 21. Accordingly, the interface 20 is coupled to the logical transmitter path 27 performing a filtering for band limitation in filter 22 of any data to be transmitted. For instance, filter 22 may comprise a root raised cosine or a square root raised cosine filter.

The RF-transceiver 2 also comprises one or more logical receiver paths 28 and 29. Each receiver may be configured to receive signals according to one or more mobile communication standards. The first logical receiver path 28 may be utilized to receive and process signals according to one or more third generation mobile communication standards while the second logical receiver path 29 is used to process signals according to one or more second mobile communication standards like GSM or GSM/EDGE. Output signals of both logical receiver paths 28, 29 are coupled to filters 23 and 24 and coupled to the digital interface 20. The RF-transceiver 2 and the digital interface 20 are also coupled to an oscillator 25 for providing a clock signal thereto.

When transmitting data, the base band unit 1 arranges the symbols to be transmitted in packets and sends the packets via the digital interface 10 to the RF-transceiver device 2. Together with the data to be transmitted the base band unit may also select one or more commands requesting a desired communication standard including a specific center frequency, a filter selection or a desired output power by the RF-transceiver 2. For this purpose, the base band unit 1 and the RF-transceiver 2 may communicate via both digital interfaces using a packet oriented communication, wherein data to be transmitted as well as commands are arranged in a frame structure, referred to as telegram. FIG. 2 shows an example of such telegram. The telegram may comprise a synchronization field having a first plurality of synchronization bits sync to facilitate clock phase selection in the interface receivers. In one embodiment, the bit pattern may be fixed and chosen for good auto correlation properties.

Following the synchronization field, the telegram structure comprises a header field “Header” having the length of 8 bits, in one embodiment wherein the first three bits may indicate a payload size while the next four bits indicate a logical channel type of the current telegram. Finally, in one embodiment, a clear to send bit is added as last bit of the header field. Following the header field, the telegram structure comprises a payload field “Payload” of variable length as indicated by the first three bits of the header field. In one embodiment, the payload field comprises a packet having one or more commands, and parameters assigned to the command. Depending on the logical channel type it may also comprise a plurality of data to be transmitted or received data to be further processed. In one embodiment, following the last bit of the payload field and of any telegram a guard time of at least one bit period is provided.

FIG. 1B shows a schematic view of an RF-transceiver 2, wherein one or more logical elements of the RF-transceiver according to FIG. 1A may be implemented in shared devices. The RF-transceiver 2 comprises a plurality of sub-circuits wherein those sub-circuits are combined in an RF-transceiver front-end 2b. In this respect, the term “sub-circuit” may represent a single circuit designed to achieve a single purpose or a group of circuits which may be grouped together because of some logical or structural connections between. For instance, the sub-circuits can be logically combined in one or more receiver paths and transmitter path. An example of a sub-circuit comprising a plurality of circuits logically combined is a phase-locked loop. In a phase-locked loop, a frequency divider circuit with an adjustable frequency ratio, a phase comparator circuit and a voltage controlled oscillator circuit may be grouped together. Such phase locked loop can be used in the transmitter paths as well as in the receiver paths. An amplifier chain having a plurality of different amplifiers some of them having different adjustable gain can also be grouped together in on embodiment.

Sub-circuits may comprise one or more adjustable parameters in order to change signal processing behavior of the respective sub-circuit. The phase-locked loop may be considered as a non-limiting example for such a sub-circuit, wherein a control voltage of the resonance frequency of a voltage controlled oscillator may represent a first adjustable parameter. An adjustable divider ratio of a frequency divider may represent a second parameter of the phase-locked loop. Supply terminals as well as signal terminals on the surface of the chip may provide the required supply voltage and current and useful signals to the elements, devices and units of the RF-transceiver front-end 2b.

In one embodiment, the RF-transceiver front-end 2b comprises a structural transmitter path and a structural receiver path. Accordingly, the transmitter path may be used to transmit signals according to one or more mobile communication standards, particularly according to the second and third generation mobile communication standards. Alternately, the front-end 2b may comprise more than one transmitter or receiver path. For instance, the RF-transceiver front-end 2b may comprise a first transmitter path to provide signals according to a first mobile communication standard, and a second transmitter path for signals according to a second mobile communication standard. For example, the first mobile communication standard can be any of the second generation mobile communication standards. The second mobile communication standard may comprise at least one of the any third generation or fourth generation mobile communication standard. Both transmitter paths may be completely separated or may share one or more sub-circuits.

The transmitter path comprises an rΦ-converter 205b having two input terminals for base band signal components I and Q. Those signal components are provided by the digital RF interface 20b connected to the base band device (not shown herein). The signal components I and Q represent a digital signal pattern corresponding to the data content to be transmitted. The I and Q signal components are converted by the rΦ-converter 205b to a phase portion Φ and an amplitude portion r. The phase portion Φ is applied to a phase modulator 206b comprising a phase-locked loop. The phase modulation component Φ may be used to adjust a frequency divider ratio in a phase-locked loop of the phase modulator 206b.

Adjusting the frequency divider portion results in a phase modulation of a carrier signal provided at the output of the phase modulator 206b and applied to an adjustable band pass filter 207b. The bandpass filter 207b can be adjusted externally such that the filter 207b suppresses undesired signal products generated by the phase-locked loop of a modulator 206b, for instance sub-harmonic, harmonic portions or crosstalks having their origin in the base band signal components.

The amplitude portion r is applied to an adjustable amplifier 208b. The amplifier 208b may comprise a programmable gain amplifier (PGA) with discrete amplification gain or a voltage gain amplifier with analog amplification gain. A second input terminal of the adjustable amplifier 208b may be connected to an output terminal of the band pass filter 207b. The phase modulated signal applied to the adjustable amplifier 208b is modulated in response to the amplitude portion r. Finally, an output terminal of the adjustable amplifier 208b is connected to an input terminal of a power amplifier 209b. In one embodiment, the output of the power amplifier 209b may be coupled to a terminal 21b on the surface of the semiconductor substrate of the RF-transceiver front-end 2b. A signal provided thereon is transmitted via an externally arranged antenna (not shown herein).

The receiver path of the RF-transceiver front-end 2b comprises a terminal 22b, on which a signal received by an antenna (not shown herein) is applied. The terminal 22b is connected to a first low noise amplifier 204b. The low noise amplifier 204b comprises an adjustable gain with a very low-noise figure to amplify the received signal without generating additional inter modulation products or other kind of spurious signals. The low noise amplifier 204b may comprise a single low noise amplifier or an amplifier chain with a plurality of low noise amplifiers connected in series. Some of those amplifiers may comprise an adjustable gain.

An output of the low noise amplifier 204b is connected to an adjustable band pass filter 203b. The pass band center frequency of the adjustable band pass filter 203b may be selected in response to a corresponding control signal applied to a control terminal. The band pass filter 203b may also comprise a plurality of single filters, each of them having different and partly overlapping pass bands with different center frequencies. Some of those filters may also comprise an adjustable pass band. For instance, the filter 203b may comprise a plurality of different filters each of them having a pass band in different frequency areas according to a desired communication standard. Depending on the center frequency and the band width of the signal received via the antenna, one of those filters may be selected and its pass band center frequency adjusted accordingly.

The output of the band pass filter 203b may be coupled to a further amplifier 201b and to an I/Q-demodulator 200b. The I/Q-demodulator 200b comprises a local oscillator input connected to a phase-locked loop 210b. Depending on a center frequency of a received RF signal, the phase-locked loop may provide a corresponding local oscillator signal for I/Q-demodulation in the I/Q-demodulator 200b. The demodulated signal components I′ und Q′ are provided as digital signals at output terminals of the RF-transceiver front-end 2b. While in this embodiment, only a single receiver path shown, the RF-transceiver device 2 and the RF-transceiver front-end 2b may comprise more than one receiver path. A first receiver path may be used to process received signals according to a first mobile communication standard and a second receiver path can be used to process signals according to a second mobile communication standard. One or more elements of the receiver paths can be used as shared elements by both paths. Both receiver paths can also be utilized for RX diversity to improve reception quality.

The RF-transceiver device 2 illustrated in FIG. 1B also comprises a controller unit 20b with a digital interface as indicated in the embodiment according to FIG. 1A. The controller unit 20b is connected to the I/Q-demodulator 200b and the rΦ-modulator 205b of the RF-transceiver front-end 2b. The controller 20b is also coupled to an interface (INT) 24b, connected through a bus to the plurality of sub-circuits in the receiver and transmitter path as shown herein. For instance, interface 24b is coupled via the bus to the phase-locked loop 210b, both amplifiers 201b and 204b and to the adjustable filter 203b of the receiver path. Interface 24b is also connected through the bus to the phase modulator 206b and the phase-locked loop arranged therein, to the adjustable filter 207b and both amplifiers 208b, 209b of the transmitter path.

During operation the base band device transmits one or more telegrams having command and control packets through the digital interface to the RF-transceiver device 2. The controller unit 20b receives the telegrams, retrieves the control packet and processes them. The controller unit 20b may also select adjustment parameters for the different sub-circuits and elements in the RF-transceiver front-end 2b according to the command within the telegram.

Due to the variety of different operating modes, a plurality of packets including commands for the different modes has to be sent. At the same or similar time, the digital interface connecting the base band device and the RF-transceiver device may be used to exchange telegrams with data to be transmitted or data to be received. Further, a time scheduling mechanism used to synchronize data transmission and reception in the RF-transceiver front-end may be generated and exchanged as well in one embodiment. Consequently, data traffic between the base band device and the RF-transceiver could be heavy and should be reduced to allow a more flexible use of the resource.

Generally, the RF-transceiver 2 may be switched into different modes of operations subsequent to each other. Normally, in one embodiment, switching into a specific mode of operation requires a telegram sent by the base band device having a specific logical channel type which may be followed by a time accurate strobe message indicating the execution of the command at a specific time. However, different subsequent modes of operation are often known to the base band device. For instance, data may be transmitted according to a specific mobile communication standard while afterwards the RF-transceiver is to be switched into a receiving mode for signals according to the standard. Since the communication standard as well as the size of the data to be transmitted is known, the base band device may “know” the requirements of subsequent modes of operation for the RF-transceiver device.

To reduce the data traffic on the digital interface 20b particularly for control commands, the base band device may generate in one embodiment a telegram with a payload having included a specific command requesting a transition from a first operating state to at least one second subsequent operating state by the RF-transceiver. Accordingly, only commands specifying a transition between subsequent modes of operation may be transmitted. Additional parameters may further specify the first and second operating states.

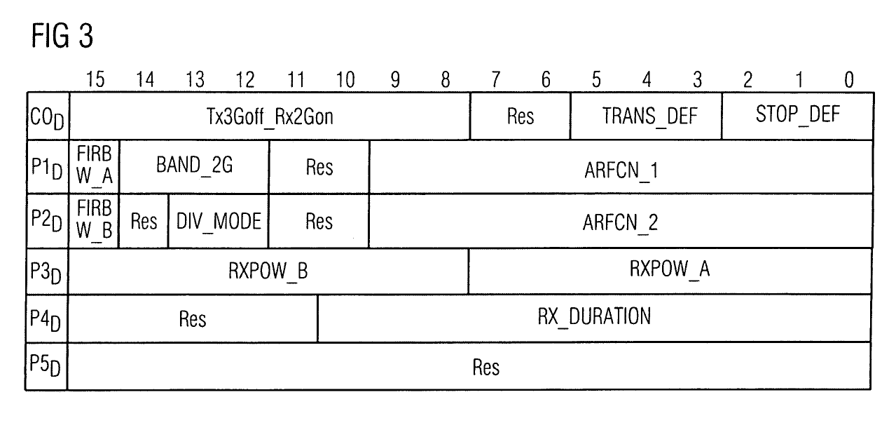

FIG. 3 shows, in one embodiment, a payload in a telegram structure comprising such command and the plurality of parameters transmitted together with a command. The payload comprises a frame structure, arranged in six rows with sixteen bits each for illustration purposes. The total payload size in one embodiment comprises 96 bits corresponding to a specific payload size coding according to the DigRF standard.

In the first row the last eight bit may comprise the command while the remaining rows are used to exchange parameters assigned to the specific command. In one embodiment, the parameters following the command may be arranged in a specific order known to the RF-transceiver front-end. The order is a non-limiting example, however, and the parameters can be re-arranged if appropriate. In this respect, the last row P5_{D} with sixteen bits does not comprise any parameter but is reserved for later use and transmitted due to the required payload size of 96 bits. In the example, the command TX3Goff_RX2Gon indicates a request for a transition from a transmission mode of operation to a receiving mode of operation by the RF-transceiver. Particularly, the RF-transceiver shall switch off the current transmitting mode of operation, wherein signals according to a third generation mobile communication standard are transmitted. Then, the RF-transceiver shall be set to a receiving mode of operation wherein signals according to a second generation mobile communication standard are to be received. Such transition may require a switching off of elements in a transmitter path and actuating of elements and circuits in the corresponding receiver path.

Consequently, in one embodiment, the command may result in a deactivation of the power amplifiers, filters and modulators of the transmitter path and an activation of low noise amplifiers, filters and demodulators of the receiver path.

Furthermore, in one embodiment, a center frequency for demodulation as well as an adjustment for the low noise amplifiers has to be selected. For this purpose, the frame structure according to FIG. 3 comprises a plurality of parameters following the command. The next table TABLE 1 summarizes the parameters used in this example packet and indicates its function.

TABLE 1

| Parameter | Description |
|---|---|
| TX3Goff_RX2Gon | Macrocommand, requesting a transition |
| | from a transmission mode of a 3^{rd} mobile |
| | generation standard to a reception mode |
| | of a 2^{nd} mobile generation standard |
| TRANS_DEF | Specifies the transition from the first |
| | operation mode to the subsequent |
| | operation mode |
| STOP_DEF | Specifies the operation mode after |
| | expiration of the subsequent operation |
| | mode (e.g. the reception mode) |
| BAND_2G | Specifies the frequency band specified in |
| | the 2^{nd} mobile generation standard |
| DIV_MODE | Defines antenna diversity mode specified |
| | in the used mobile communication standard |
| FIRBW_A | Adjust the selection filters in the |
| FIRBW_B | receiver path (used in a GSM/EDGE |
| | reception mode), second parameter only |
| | used in antenna diversity mode |
| ARFCN_1 | Specifies the frequency channels within |
| ARFCN_2 | the frequency band set by BAND_2G |
| | specified in the 2^{nd} mobile generation |
| | standard, ARFCN_2 is used only with Dual |
| | Downlink Carrier (DDC) |
| RXPOW_A | Adjust the gain of amplifiers in the |
| RXPOW_B | receiver path, second parameter used only |
| | in antenna diversity mode |
| RX_DURATION | Specifies duration of subsequent |
| | operation mode (in this example given by |
| | a multiplicity of a GSM/EDGE symbol |
| | duration) |
| Res | Reserved (not used) |

In one embodiment, TX3Goff_RX2Gon is the name for the macro command requesting a transition from a transmission mode of a 3^{rd} mobile generation standard to a reception mode of a 2^{nd} mobile generation standard. It should be noted that other names can be used for such a macro command depending on the programming language and model.

Parameters FIRBW_A and FIRBW_B indicate a selection filter adjustment for an optional diversity reception. The parameter BAND_{—}2G specifies the center frequency and center band for receiving signals according to a second generation mobile communication standard. DIV_MODE represents a parameter specifying antenna diversity. Accordingly, channel adjustments for the signals to be received on the different channels are specified by parameters ARFCN_1 und ARFCN_2. If an antenna diversity reception mode is activated, an amplification gain of a low noise amplifier should be adjusted to prevent non-linear amplification by the low noise amplifiers. For this purpose, the parameters RXPOW_A and RXPOW_B are used to adjust parameters for the low noise amplification gain. These parameters may indicate an estimated power of signals to be received. Finally, the parameter RX_DURATION specifies the duration for signal reception. The duration may comprise a multiplicity of a symbol duration according to the mobile communication standard of the signals to be received.

Furthermore, the frame structure defines the parameters TRANS_DEF and STOP_DEF in the first row. The first parameter TRANS_DEF describes the transition from the transmission mode to the receiving operation mode. This may include for instance an order for switching on or off the various elements of the RF-transceiver. For example, the parameter TRANS_DEF may indicate that phase-locked loop circuits which are used for the former transmission mode shall be re-used in the subsequent receiving mode. Since the duration of the receiving mode is known by the parameter RX_DURATION, the parameter STOP_DEF specifies an operating state after terminating the reception mode at the end of the duration defined by the parameter RX_DURATION. This parameter may also comprise information about the operating states of various elements in the RF-transceiver front-end. For instance, the parameter STOP_DEF may define the state or after the expiration of the duration of former the phase-locked loop, filters or amplifiers used during reception mode.

Defining parameters specifying the transition and the operating state after termination of the corresponding operation mode may reduce the amount of data required to be exchanged through the digital interface between the base band device and the RF-transceiver front-end. The combination of a command with several parameters defining the transition between at least subsequent modes of operation reduces the overall amount of telegrams with configuration payload exchanged between the base band device and the RF-transceiver. Further, it provides a higher flexibility and time saving in respect to lock-in times for phase-locked loops or other devices of the RF-transceiver front-end used for the different modes of operation.

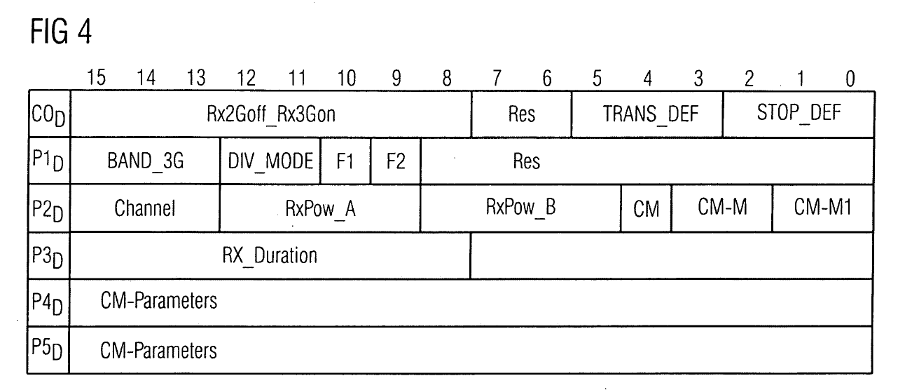

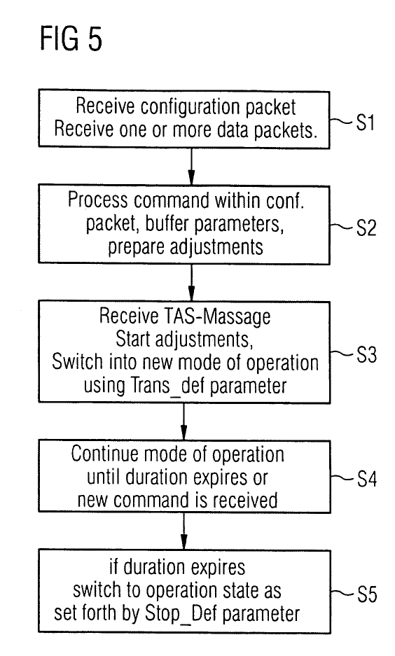

FIG. 4 shows another embodiment of a configuration packet being exchanged by a telegram including a command requesting and specifying a transition between two subsequent modes of operation. In this example the RF-transceiver is first set into a receiving mode for signals according to a second generation mobile communication standard. The command requires the transition from a receiving operation mode for signals according to a second generation mobile communication standard, like GSM/EDGE to a mode of operation for receiving signals according to a third generation mobile communication standard like WCDMA or UMTS. Basically the command RX2Goff_RX3Gon requests the RF-transceiver to terminate signal reception of signals according to GSM/EDGE and start receiving signals according to UMTS, WCDMA or CDMA2000 for example.

The configuration packet comprises an 8 bit command field in the command row C0_{D} beginning after the first eight bits of the packet and a parameter field having a length of the remaining 88 bits. The following table TABLE2 indicates the function and meaning of the different parameters used in the configuration packet according to FIG. 4.

TABLE 2

| Parameter | Description |
|---|---|
| RX2Goff_RX3Gon | Macrocommand, requesting a transition |
| | from a reception mode of a 2^{nd} mobile |
| | generation standard to a reception mode |
| | of a 3^{rd} mobile generation standard |
| TRANS_DEF | Specifies the transition from the first |
| | operation mode to the subsequent |
| | operation mode |
| STOP_DEF | Specifies the operation mode after |
| | expiration of the subsequent operation |
| | mode (e.g. the reception mode) |
| BAND_3G | Specifies the frequency band specified |
| | in the 3^{rd} mobile generation standard |
| DIV_MODE | Defines antenna diversity mode specified |
| | in the 3^{rd} mobile generation standard |
| CHANNEL | Specifies a frequency channel to be used |
| | in the 3^{rd} mobile generation standard |
| F1 | Filter selection in the receiver path |
| F2 | (used in UMTS or 3GPP reception mode), |
| | second parameter only used in antenna |
| | diversity mode |
| RxPow_A | Adjust the gain of amplifiers in the |
| RxPow_B | receiver path, second parameter used |
| | only in antenna diversity mode |
| RX_DURATION | Specifies duration of subsequent |
| | operation mode (in this example given by |
| | a multiplicity of a GSM/EDGE symbol |
| | duration) |
| CM | Third generation mobile communication |
| CM-M | standards may comprise a compressed mode |
| CM-M1 | (3GPP TS 25.212) to allow monitoring |
| CM-PARAMETERS | while maintain constant data rate |
| Res | Reserved (not used) |

In the above embodiment, the configuration packets also comprise parameters configuring the so-called compressed mode specified in the 3GPP mobile communication standard (3GPP TS 25.212) which is included herein by reference in its entirety.

The compressed mode is used to enable handover of a mobile communication system from a first base station to a second base station at a different frequency. For this purpose, transmission or reception of a third generation mobile communication signal must be interrupted for a short time. During the interruption the RF-transceiver may change to the frequency of the second base station, for example to measure a strength of the received signal transmitted by the second base station or read system information.

To transmit a high data volume in the remaining now shorter period of time, the data is compressed. This can be achieved by various ways. In every case, output power during signal transmission concerned is increased to maintain adequate signal quality. The parameters CM and CM-M define the mode used for data compression. The further parameters CM-M1 and CM-Parameters indicate possible transmission gaps and the power of the signal to be received during reception of compressed data. It may also comprise information about the duration and the new center frequency, which has to be adjusted during transmission interruption.

FIG. 5 illustrates a method for receiving configuration and data packets, processing them and adjusting the RF-transceiver accordingly. While the exemplary method is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention.

In step S1, a telegram having a configuration packet provided by the base band device is received together with one or more telegrams including data packets. The receiving order of the packets may vary. For example, the base band device may first transmit one or more data telegrams with packets followed by a telegram including a configuration packet. The configuration packet may also be sent first followed by one or more data packets. It may be useful in one embodiment that a controller device in the RF-transceiver may send an acknowledgment signal indicating a successful reception of a telegram. In addition, the digital interface controller of the receiver may transmit a clear to send (CTS) signal thereby indicating that the controller of the RF-transceiver accepts the reception of a new telegram.

In step S2, the packets stored in the payloads of the received telegrams are processed and the command within the configuration packet retrieved. The parameters within the configuration packet are buffered for later use. Further, the controller may start preparing adjustments for the required mode of operation or the transition using the buffered parameters and the command within the configuration packet. During the preparation, the controller may also send a further clear to send signal to the base band device indicating that the controller may accept additional data packets. The RF-transceiver may also indicate the end of preparation and send a ready to execution signal.

The base band device may now generate a time accurate strobe message (TAS) assigned to an execution command and send the message to the controller device of the RF-transceiver. Upon reception of a TAS message (time accurate strobe message) the RF-transceiver may begin the transition from the first mode of operation to the at least one subsequent mode of operation using the parameters received previously in the configuration packet. Particularly, one or more elements or circuits of the RF-transceiver front-end within the RF-transceiver may be adjusted according to the content specified in the TRANS_DEF parameter field of the configuration packet.

After completing the transition in step S3, the RF-transceiver continues the current mode of operation as set forth by the command in the configuration packet using the previously buffered parameters in step S4. For instance, the subsequent mode of operation may be continued in Step S4 until the duration of the current mode of operation expires or a new configuration packet with a command requesting a transition into a new mode of operation is received by the controller device of the RF-transceiver.

If the duration of the mode of operation expires, the RF-transceiver is switched to a mode of operation in step S5 as indicated by the STOP_DEF parameter of the previously received configuration packet.

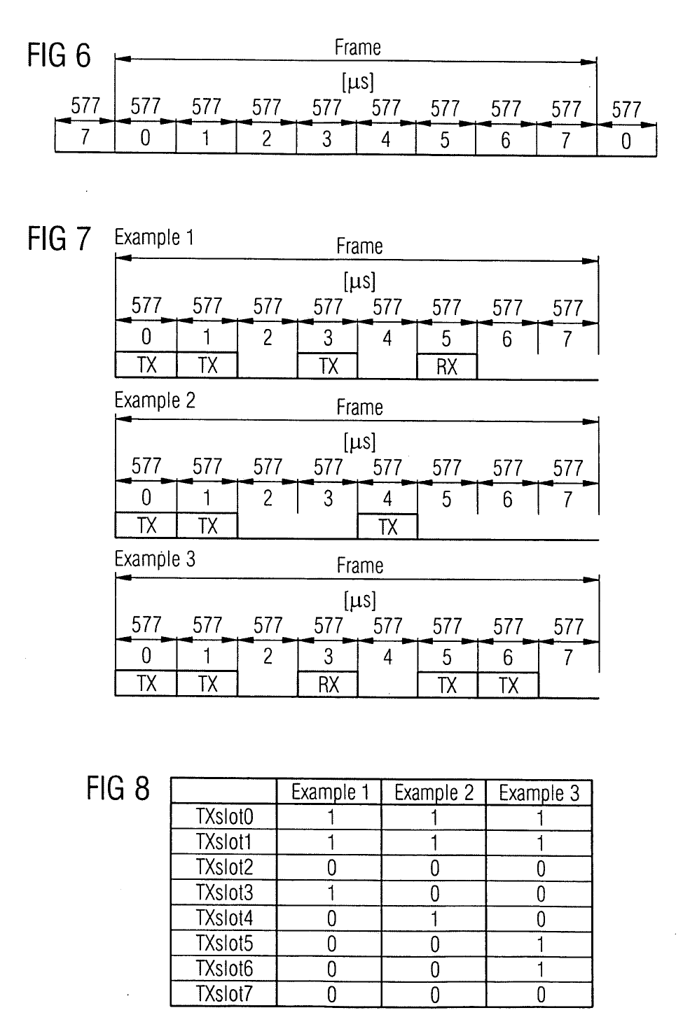

Depending on a used mobile communication standard, the RF-transceiver may transmit or receive a pulsed signal, each of the pulsed signals comprising a content of a data packet to be received or transmitted. For example, the GSM/EDGE mobile communication standard uses a time division duplex method (TDD) to transmit and receive signals. Accordingly, a specific time span also referred to as a frame comprising the duration of roughly 4.6 msec is divided into eight time slots as indicated in FIG. 6.

Each time frame is followed by a subsequent time frame also comprising eight time slots, a time slot having the duration of 577 μs.

According to the GSM/EDGE mobile communication standard an RF-transceiver may transmit a pulsed signal having data content in a single time slot. Still, a plurality of pulsed signals may be transmitted or received within a time frame comprising eight time slots. However, as indicated in example 1 of FIG. 7, a RF-transceiver may transmit several pulsed signals in a plurality of time slots indicated by TX and receive a data packet in a signal in at least one time slot indicated by reference RX. In example 1 of FIG. 7, the RF-transceiver will transmit a data packet in a pulsed signal during in time slots 0, 1 and 3 while receiving a data packet during time slot 5.

Due to the fact that the GSM/EDGE mobile communication standard requires transmission and reception of signals on different frequencies, a switch over between transmitting and receiving signals may require at least one time slot. In example 1 of FIG. 7, the RF-transceiver may switch from the transmission path to the reception path within the time slot 4. Switching procedure may comprise adjusting a phase locked loop to a new frequency, activating amplifiers in the reception path, adjusting filters and the like.

In example 2 of FIG. 7, the RF-transceiver may only transmit signals within a frame. In example 3, the RF-transceiver may transmit two data packets in pulsed signal during time slots 0 and 1, then switch over to a reception mode and receives a data packet in time slot 4. Afterwards it may switch back to a transmission mode of operation and transmit two further data packets in time slots 5 and 6.

Accordingly, the three examples shown herein may require different modes of operation by the RF-transceiver. For instance, the example 1 may require a first mode of operation, wherein some or all elements and circuits of a transmitter path may be activated. In a second mode of operation in time slots 2, 6 and 7 some circuits of the transmitter path can be deactivated. In time slot 4, the RF-transceiver has to switch from a transmitter path to a receiver path. The switching procedure may include deactivating elements and circuits in the transmitter path, selecting a new center frequency for a phase-locked loop shared by transmitter and receiver path and activating the low noise amplifier in the receiver path. After receiving a signal during time slot 5, the low noise amplifiers and other elements of the receiver path can be deactivated.

Example 2 of FIG. 7 may comprise only two modes of operation and two transitions in between. Starting with a transmission mode of operation in time slots 0 and 1, power amplifiers and other elements of the transmitter path can be deactivated or set to a low power mode during time slots 2 and 3, but must be activated again in time slot 4. After sending a pulsed signal during time slot 4 the power amplifiers and maybe the modulator circuitry as well can be deactivated again.

Finally, example 3 shows a frame structure with four transmission slots TX and one receiving slot RX. In this example the receiving slot RX corresponding to time slot 3 is arranged between two transmission slots each. As illustrated in example 3 time slot 2 and 4 are left blank to allow a switch over between signal transmission and reception modes and vice versa, respectively.

FIG. 8 shows a table indicating the time slots to be activated in the three examples of FIG. 7. A time slot is indicated as active with a logical number 1 and indicated as inactive with a logical number 0. Still, the table does not provide any information about receiving time slots during a GSM/EDGE frame. Nevertheless, it may provide information about different modes of operation and required the transitions in between.

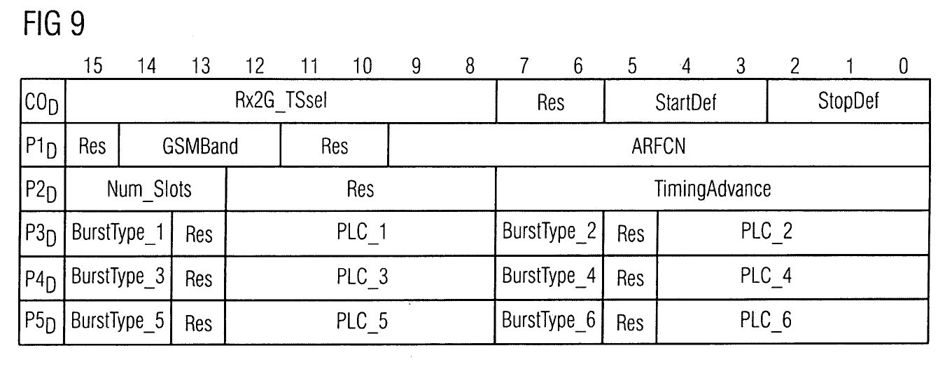

FIG. 9 shows an embodiment of a configuration packet transmitted by the base band device to the controller of the RF-transceiver within a telegram for configuring the RF-transceiver 4 for up to 6 subsequent GSM/EDGE transmitting time slots. The command RX2G_TSsel within 8 to bit 15 bit of the configuration packet requests a transition from a reception mode of operation of a second generation mobile communication standard to a transmission mode of operation in the same standard. The table TABLE 3 summarizes the parameter used in the configuration packet shown in FIG. 9 for such transition in the GSM-standard and provides a short description of the parameters.

TABLE 3

| Parameter | Description |
|---|---|
| Rx2G_TSsel | Macrocommand, requesting a transition |
| | from a reception mode of a 2^{nd} mobile |
| | generation standard to a transmission |
| | mode of a 2^{nd} mobile generation standard |
| StartDef | Specifies the transition from the first |
| | operation mode to the subsequent |
| | operation mode |
| StopDef | Specifies the operation mode after |
| | expiration of the subsequent operation |
| | mode (e.g. the transmission mode) |
| GSMBand | Specifies frequency band for the |
| | transmission mode |
| ARFCN | Specifies the frequency channel of |
| | frequency band in which data shall be |
| | transmitted |
| Num_Slots | Defines number of slots in which data |
| | shall be transmitted |
| TimingAdvance | Time positioning of GSM transmit burst |
| | relative to slot grid of the base |
| | station |
| BurstType_1 | Specifies the type of a GSM-Burst to be |
| to | transmitted (GSM, EDGE or Access Burst) |
| BurstType_6 | for the first to sixth timeslot |
| PCL_1 | Specifies the power class level for the |
| to | GSM-Burst to be transmitted (GSM, EDGE |
| PCL_6 | or Access Burst) for up to six timeslots |
| Res | Reserved (not used) |

When transmitting signals during different time slots within a single frame the configuration packet according to FIG. 9 is able to configure up to 6 subsequent transmission time slots configured.

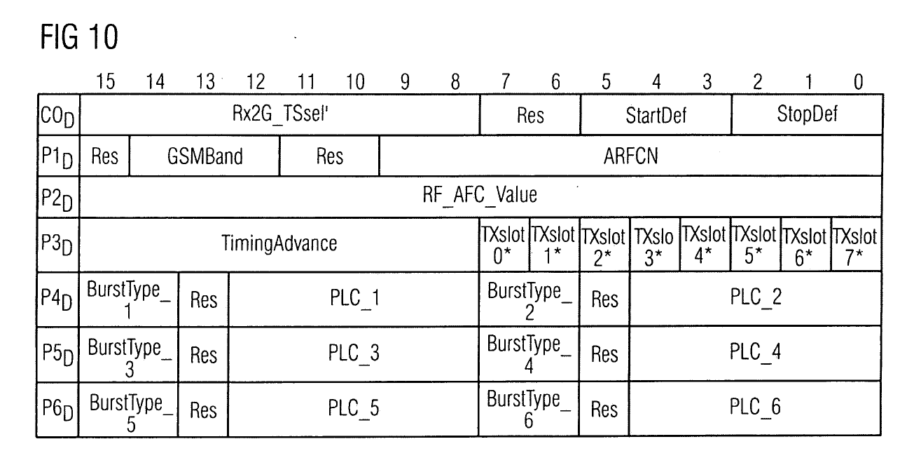

FIG. 10 shows a configuration packet including a command for transmitting signals in one or more time slots, wherein the time slots may be spread throughout a time frame. For instance, a time frame according to example 2 of FIG. 7 can be configured with the configuration packet according to FIG. 10.

The configuration packet corresponding to a user defined payload transmitted in a telegram according to the DigRF standard is arranged in seven rows having sixteen bits each. The first row C0_{D} comprises a configuration command and adjustment parameters START_DEF and STOP_DEF, respectively. Each parameter comprises a bit length of three bits, the parameter START_DEF defining the operating state at the transition from the previous operating state and the parameter STOP_DEF defining the operating state at the end of the time frame in which the signals are transmitted. Table TABLE 4 shows the parameters specified in the configuration packet and provides a short description.

TABLE 4

| Parameter | Description |
|---|---|
| Rx2G_TSsel’ | Macrocommand, requesting a transition |
| | from a reception mode of a 2^{nd} mobile |
| | generation standard to a transmission |
| | mode of a 2^{nd} mobile generation standard |
| StartDef | Specifies the transition from the first |
| | operation mode to the subsequent |
| | operation mode |
| StopDef | Specifies the operation mode after |
| | expiration of the subsequent operation |
| | mode (e.g. the transmission mode) |
| GSMBand | Specifies the frequency band for the |
| | transmission mode |
| ARFCN | Specifies the frequency channel of |
| | frequency band in which data shall be |
| | transmitted |
| RF_AFC_Value | Frequency correction value for VCXO |
| | utilized with automatic frequency |
| | correction (AFC) |
| TimingAdvance | Time positioning of GSM transmit burst |
| | relative to slot grid of the base |
| | station |
| TXslot_0* | Specifies, in which of the time slots of |
| to | a GSM-Burst data is to be transmitted |
| TXslot_7* | |
| BurstType_1 | Specifies the type of a GSM-Burst to be |
| to | transmitted (GSM, EDGE or Access Burst) |
| BurstType_6 | for the first to sixth timeslot |
| PCL_1 | Specifies the power class level for the |
| to | GSM-Burst to be transmitted (GSM, EDGE |
| PCL_6 | or Access Burst) for up to six timeslots |
| Res | Reserved (not used) |

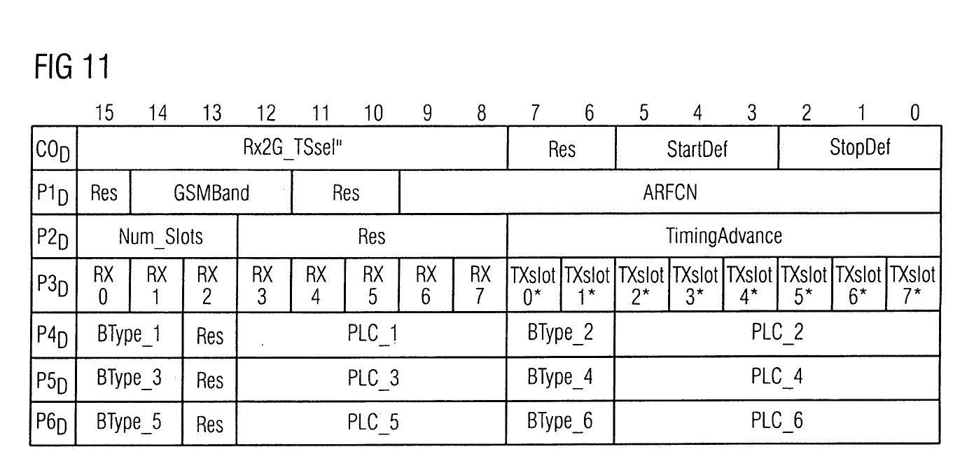

In the configuration packet according to FIG. 10 the command row C0_{D} is followed by six data rows P1_{D} to P6_{D}, in which parameters of the several transmission modes are specified. For instance, the parameter GSM BAND and ARFCN specifies the center frequency of the signals to be transmitted during time slots defined later. In payload data row P3_{D} the last eight bits specify the timing advance of the transmission mode of operation. The first eight bits correspond to the time slots TX slot 0 to TX slot 7, in which a signal is to be transmitted. The next three payload data rows P4_{D} to P6_{D} comprise parameter specifying the burst type and the corresponding power class level of the time slots. Due to the fact that the mode of operation allows only transmitting data within six time slots of a time frame, it is sufficient to define only six different burst types and the corresponding power class levels at maximum. Nevertheless, the telegram allows specifying more than one subsequent time slots for transmission. FIG. 11 shows a further embodiment of a configuration packet having a command row CO_{D} of sixteen bits and six rows of payload data P1_{D} to P6_{D}, each payload data row comprising also sixteen bits.

With a configuration packet according to FIG. 11 it may be even possible to specify time slots for receiving data as well as time slots for transmitting data during a frame. The following table provides a definition of the parameters used in the configuration packet according to FIG. 11 and a short description thereof.

TABLE 5

| Parameter | Description |
|---|---|
| Rx2G_TSsel‘’ | Macrocommand, requesting a transition |
| | from a reception mode of a 2^{nd} mobile |
| | generation standard to a transmission |
| | mode of a 2^{nd} mobile generation standard |
| StartDef | Specifies the transition from the first |
| | operation mode to the subsequent |
| | operation mode |
| StopDef | Specifies the operation mode after |
| | expiration of the subsequent operation |
| | mode (e.g. the transmission mode) |
| GSMBand | Specifies the frequency band for the |
| | transmission mode |
| ARFCN | Specifies the frequency channel of |
| | frequency band in which data shall be |
| | transmitted |
| Num_Slots | Specifies the number of slots used |
| TimingAdvance | Time positioning of GSM transmit burst |
| | relative to slot grid of the base |
| | station |
| Rx0 | Specifies, in which of the time slots of |
| to | a GSM-Burst data is to be received |
| Rx7 | |
| TXslot0* | Specifies, in which of the time slots of |
| to | a GSM-Burst data is to be transmitted |
| TXslot7* | |
| BType_1 | Specifies the type of a GSM-Burst to be |
| to | transmitted or received (e.g. GSM, EDGE |
| BType_6 | or Access Burst) for up to sixth |
| | timeslots |
| PCL_1 | Specifies the power class level for the |
| to | GSM-Burst to be transmitted (GSM, EDGE |
| PCL_6 | or Access Burst) for up to six |
| | timeslots, adjusts amplifier gain |
| Res | Reserved (not used) |

In the example, the parameter Num_slots defines the number of slots of a time frame in which a signal is either to be transmitted or received. In the third payload data row P3_{D} the bits 15 to 7 define the reception slots wherein a value of 1 corresponds to a time slot within the time frame for a signal to be received. The bits 7 to 0 within the third payload data row may be used to define the corresponding transmission slots. For example considering example 3 of FIG. 7 the third payload data row P3_{D} may comprise the bit sequence 00010000 for bit positions 15 to 8 and the bit sequence 11000110 for bit positions 7 to 0 representing the time slots within the time frame.

The next three payload data rows P4_{D} to P6_{D} comprise two parameters of type BType and two parameters PCL defining the power class level corresponding to the respective burst type. The parameter BType specifies the type of signal to be received by the corresponding receiving time slot or to be transmitted by the corresponding transmission time slot. Due to the fact that a signal can be transmitted or received only within six time slots of a time frame, it is sufficient to define only six subsequent time slots therein.

In respect to example 3 mentioned above, the parameter BType1 and the corresponding power class level as well as the parameter BType2 and its corresponding power class level specifies the parameters for the transmission time slots 0 and 1. The burst type parameter BType_3 specifies the parameter for the receiving time slot Rx3. Accordingly, the burst type parameters BType_4, BType_5 and the assigned power class level parameters PCL_4, PCL_5 may correspond to the transmission time slots TX5 and TX6 as shown in example 3. The last parameter B type_6 and the assigned power class level parameter PCL_6 can be left blank. Since active time slots are indicated and defined in row P3_{D}, the RF-transceiver may adjust its circuits and elements accordingly and in respect to the parameter transmitted in the configuration packet.

With the embodiment according to FIG. 11, it is possible to specify and define a time frame comprising transmission and reception slots with a single configuration packet. Accordingly the configuration packet may comprise one or more transitions indicated by the command Rx_{—}2G_TSsel′ and defined more precisely using the parameters in the payload data rows.

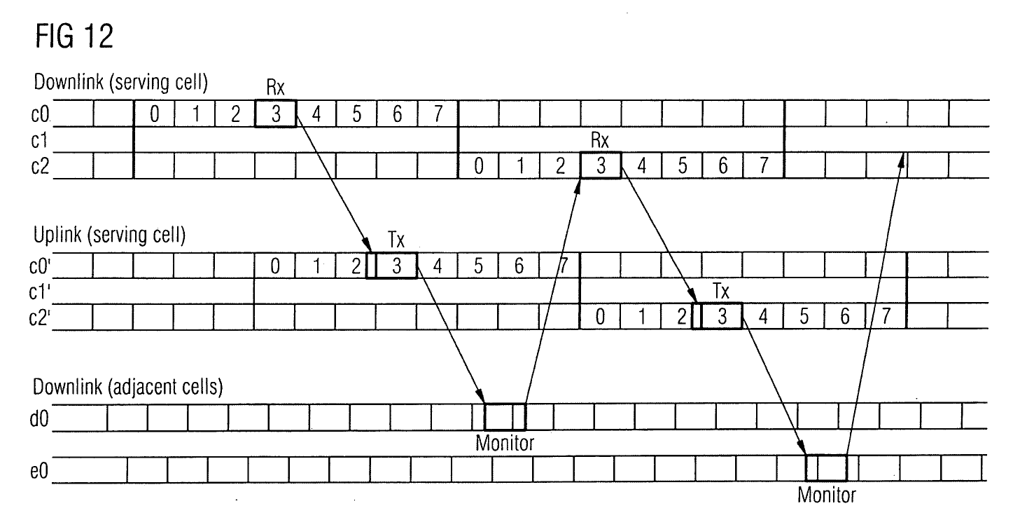

A further aspect is related to the requirement of monitoring adjacent channels during transmission or reception of signals. FIG. 12 shows a diagram illustrating the hopping mechanism for the GSM/EDGE mobile communication standard including monitoring adjacent channels. According to the standard, a time frame comprises eight subsequent time slots in each channel for the downlink and the uplink. In this aspect, the term “downlink” refers to a base station transmitting data to a base station. Accordingly the term “uplink” refers to a mobile communication system sending a signal to a base station.

For uplink and downlink different center frequencies may be used. During data exchange between base station and mobile communication system, the latter may monitor adjacent channels for transmitting data. Such procedure may be required in case a switch over from a mobile communication system to an adjacent base station cell is necessary. The mobile communication system may initiate a switch over to an adjacent channel for a downlink in case signal quality in the previous channel may decrease so that error free transmission is no longer possible. Also, a base station can request a switch over.

For preparation of a smooth switch over, the mobile communication system may periodically switch to adjacent channels measuring and determining parameters indicating signal quality in those channels. Those channels may be handled by a different base station. The mobile communication system may determine whether other mobile communication systems transmit in those channels. Network management will ensure that two adjacent cells (base station) will not use the same downlink or uplink channels. In the embodiment according to FIG. 12, the mobile communication system particularly the RF-transceiver of the mobile communication system may use time slot 3 in channel C0 for a signal reception RX.

In this aspect, the downlink in the serving cell may comprise three different channels named C0 to C2. As set forth in the GSM and GSM/EDGE mobile communication standards, the frames between the downlink and the uplink are shifted by three time slots. If therefore a signal is received in the fourth time slot, the RF-transceiver may also transmit a signal TX in the fourth time slot in the uplink. The shift between the downlink and the uplink allows the RF-transceiver elements and circuits in the mobile communication system to switch to a different frequency as required After transmitting a signal in the fourth time slot in the uplink channel c0′ of the serving cell, the RF-transceiver may switch again to a further downlink channel d0 of an adjacent cell and may monitor this channel during a further time slot. In the channel d0 the adjacent cell may transmit information about the signal quality and the traffic of the adjacent cell.

After monitoring the downlink channel D0 of the adjacent cell, the mobile communication system may switch back to the channel c2 of the downlink in the serving cell and receive a data packet in the fourth time slot of the downlink frame. After receiving the signal for a time slot duration, the mobile switches to the uplink channel c2′ of the serving cell and then starts transmitting.

As indicated in FIG. 12, the RF-transceiver of the mobile communication system switches periodically between the downlink and the uplink of the serving cells and downlink channel of an adjacent cell for monitoring purposes. While the different transitions and operating states may be configured using several configuration packets, it is useful to implement such periodic procedure in a single configuration packet to relax any time critical data exchange between a base band device and an RF-transceiver front-end.

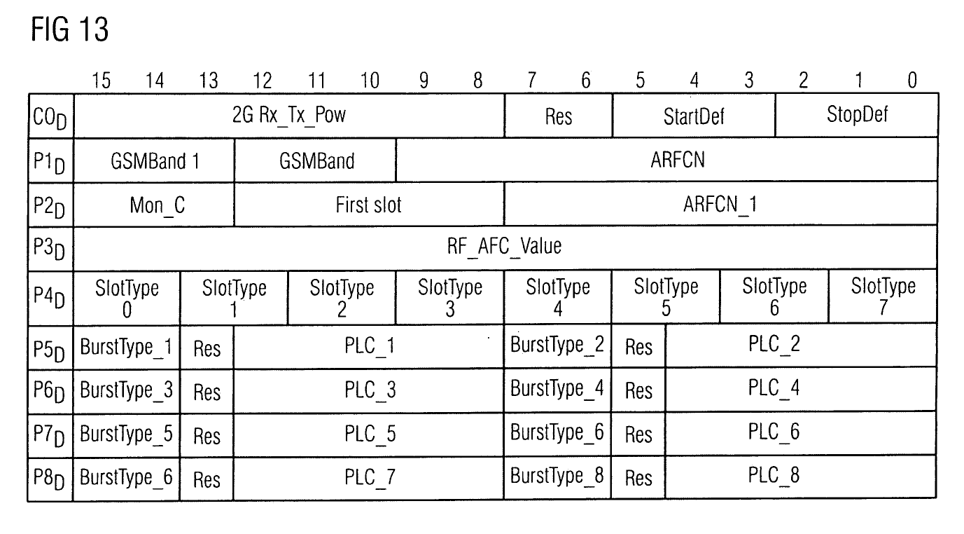

FIG. 13 shows a configuration packet arranged in command and several payload data rows having 16 bits each for illustration purposes. The configuration packet comprising a length of 144 bits may be transmitted as a user defined payload in a telegram according to the DigRF standard by the base band device to an RF-transceiver device. The command 2GRx_Tx_POW within the configuration packet requests the RF-transceiver to switch periodically between three different operating states including a reception mode, a transmission mode and a monitoring mode. The following table TABLE 6 illustrates the parameter used in the configuration packet and gives a short description of them.

TABLE 6

| Parameter | Description |
|---|---|
| 2G Rx_Tx_Pow | Macrocommand, requesting a transition |
| | from a reception mode of a 2^{nd} mobile |
| | generation standard to a transmission |
| | mode of a 2^{nd} mobile generation standard |
| | and then to a monitoring mode in an |
| | adjacent channel |
| StartDef | Specifies the transition from the first |
| | operation mode to the subsequent |
| | operation mode |
| StopDef | Specifies the operation mode after |
| | expiration of the last executed |
| | operation mode (e.g. the monitoring |
| | mode) |
| GSMBand | Specifies the frequency band for the |
| | transmission and reception mode |
| GSMBand1 | Specifies the frequency band for the |
| | monitoring mode |
| Mon_C | Specifies the number of slots to be |
| | monitored |
| First Slot | Specifies the timing position of a burst |
| | in a serving cell |
| ARFCN | Specifies the frequency channel of |
| | frequency band in which data shall be |
| | transmitted or received |
| ARFCN1 | Specifies the frequency channel of |
| | frequency band in which data shall be |
| | monitored |
| RF_AFC_Value | Frequency correction value for VCXO |
| | utilized with automatic frequency |
| | correction (AFC) |
| Slot_Type0 | Specifies the type of a GSM-Burst in the |
| to | slot, whether data is be transmitted, |
| Slot_Type7 | received or monitored (e.g. GSM, EDGE, |
| | Access Burst or Monitor) for all |
| | timeslots |
| BurstType_1 | Specifies the type of a GSM-Burst in |
| to | each timeslot to be transmitted or |
| BurstType_8 | received (e.g. GSM, EDGE or Access |
| | Burst), monitoring types may also be |
| | specified |
| PCL_1 | Specifies the power class level for the |
| to | GSM-Burst to be transmitted (GSM, EDGE |
| PCL_8 | or Access Burst) or gives an estimation |
| | of the power level for a burst to be |
| | received, adjusts amplifier gain |
| Res | Reserved (not used) |

Due to the required monitoring mode of operation, the configuration packet may include two additional parameters indicating a frequency band and channel number in which data traffic and signal quality shall be monitored. The parameter Mon_C indicates the amount of monitoring slots within the time frame. The parameter “First slot” may be utilized to specify a timing position of the transmission bursts in the corresponding serving cell.

The slot types for the eight time slots are specified in the payload data row P4_{D} parameter SlotType Each slot type may indicate a GSM/EDGE transmission slot, receiving slot or monitoring slot. In the next four payload data rows P5_{D} to P8_{D} more specific information about the slot types and different time slots are specified. For instance, the parameter BurstType may comprise information about the type of the signal to be transmitted or an estimated type of a signal to be received. This information can be used to adjust, for example, the power amplifiers or the low noise amplifiers accordingly. The parameter PCL may include data for adjusting the amplifier or the filter in the respective transmitter or receiver path of the RF-transceiver.

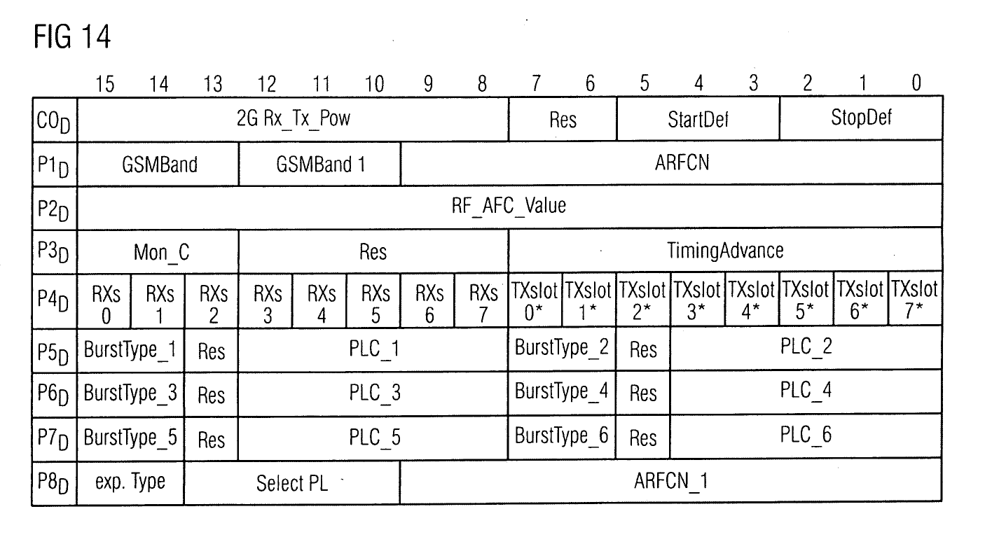

FIG. 14 shows another embodiment of a configuration packet with a user defined length for defining a complete frame according to the GSM/EDGE mobile communication standard including a monitoring slot, a transmission slot and a reception slot. In this embodiment, only one time slot of the downlink of an adjacent cell is to be monitored, specified by the parameter MON_C as indicated in table TABLE 7.

TABLE 7

| Parameter | Description |
|---|---|
| 2G Rx_Tx_Pow | Macrocommand, requesting a transition |
| | from a reception mode of a 2^{nd} mobile |
| | generation standard to a transmission |
| | mode of a 2^{nd} mobile generation standard |
| | and then to a monitoring mode in an |
| | adjacent channel |
| StartDef | Specifies the transition from the first |
| | operation mode to the subsequent |
| | operation mode |
| StopDef | Specifies the operation mode after |
| | expiration of the last executed |
| | operation mode (e.g. the monitoring |
| | mode) |
| GSMBand | Specifies the frequency band for the |
| | transmission and reception mode |
| GSMBand1 | Specifies the frequency band for the |
| | monitoring mode |
| ARFCN | Specifies the frequency channel of |
| | frequency band in which data shall be |
| | transmitted |
| RF_AFC_Value | Frequency correction value for VCXO |
| | utilized with automatic frequency |
| | correction (AFC) |
| Mon_C | Specifies the number of time slot to be |
| | monitored |
| TimingAdvance | Time positioning of GSM transmit burst |
| | relative to slot grid of the base |
| | station |
| Rxs0 | Specifies, in which of the time slots of |
| to | a GSM-Burst data is to be received |
| Rxs7 | |
| TXslot0* | Specifies, in which of the time slots of |
| to | a GSM-Burst data is to be transmitted |
| TXslot7* | |
| BurstType_1 | Specifies the type of a GSM-Burst in up |
| To | to six timeslots to be transmitted or |
| BurstType_6 | received (e.g. GSM, EDGE or Access |
| | Burst) |
| PCL_1 | Specifies the power class level for the |
| to | GSM-Burst to be transmitted (GSM, EDGE |
| PCL_6 | or Access Burst) or gives an estimation |
| | of the power level for a burst to be |
| | received, adjusts amplifier gain |
| Exp.Type | Specifies an estimation of a slot type |
| | in a time slot to be monitored |
| SelectPL | Specifies an estimated power level of |
| | the time slot to be monitored |
| ARFCN_1 | Specifies the frequency channel of the |
| | frequency band in which data shall be |
| | monitored |
| Res | Reserved (not used) |

The parameters “exp.Type” and “select PL” define an estimate power level for time slot to be monitored.

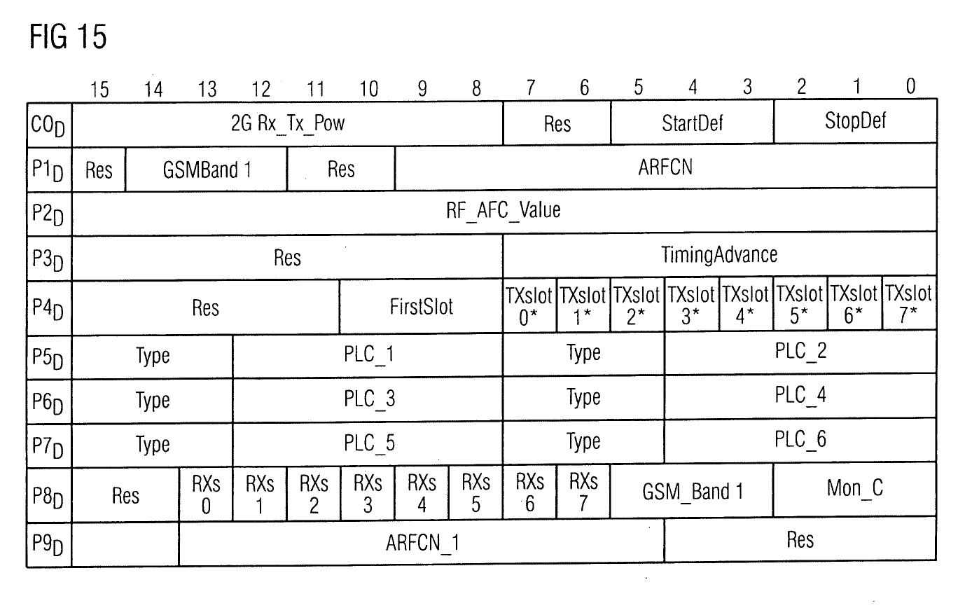

FIG. 15 shows a further embodiment of a configuration packet comprising a command 2GRxTx_POW requesting a transition between different modes of operation including a transmission mode, a reception mode and a monitoring mode according to a second generation mobile communication standard. Table TABLE 8 illustrates in overview about the parameters used in the configuration packet according to the embodiment of FIG. 15.

TABLE 8

| Parameter | Description |
|---|---|
| 2G Rx_Tx_Pow | Macrocommand, requesting a transition |
| | from a reception mode of a 2^{nd} mobile |
| | generation standard to a transmission |
| | mode of a 2^{nd} mobile generation standard |
| | and then to a monitoring mode in an |
| | adjacent channel |
| StartDef | Specifies the transition from the first |
| | operation mode to the subsequent |
| | operation mode |
| StopDef | Specifies the operation mode after |
| | expiration of the last executed |
| | operation mode (e.g. the monitoring |
| | mode) |
| GSMBand | Specifies the frequency band for the |
| | transmission or reception mode |
| ARFCN | Specifies the frequency channel of |
| | frequency band in which data shall be |
| | transmitted or received |
| RF_AFC_Value | Specifies the frequency channel of |
| | frequency band in which data shall be |
| | transmitted |
| TimingAdvance | Time positioning of GSM transmit burst |
| | relative to slot grid of the base |
| | station |
| FirstSlot | Specifies position of the first slot |
| | transmitted by the transceiver relative |
| | to the slot number of the serving GSM |
| | Base station |
| TXslot0* | Specifies, in which of the time slots of |
| To | a GSM-Burst data is to be transmitted |
| TXslot7* | |
| Type_1 | Specifies the type of a GSM-Burst in up |
| To | to six timeslots to be transmitted or |
| Type_6 | received (e.g. GSM, EDGE or Access |
| | Burst) |
| P_1 | Specifies the power class level for the |
| To | GSM-Burst to be transmitted (GSM, EDGE |
| P_6 | or Access Burst) or gives an estimation |
| | of the power level for a burst to be |
| | received, adjusts amplifier gain |
| RXs0 | Specifies, in which of the time slots of |
| To | a GSM-Burst data is to be received |
| RXs7 | |
| GSMBand1 | Specifies the frequency band for the |
| | monitoring mode |
| Mon_C | Specifies the time slot(s) to be |
| | monitored |
| ARFCN_1 | Specifies the frequency channel of |
| | frequency band in which data shall be |
| | monitored |
| Res | Reserved (not used) |

The parameter FirstSlot defines the position of a burst transmitted by the transmitter relative to a slot or burst grid of a receiving base station. In the GSM mobile communication standard the frame consists of eight slots, six of them having 156 symbols and two of them having 157 symbols. If, for instance a GSM burst is used, the burst may comprise 157 symbols instead of 156. Since the position of those two slots in a frame structure is fixed, the parameter FirstSlot specifies the position of the first 157 symbol slot relative to an existing slot and frame structure of a base station.

Another aspect relates to the fact that often the duration of specific operation is known due to the fact that those modes are specified and defined in the corresponding mobile communication standard. For instance, the frame in the GSM/EDGE mobile communication standard as well as in the UMTS/WCDMA or any 3GPP mobile communication standards is well-known. To activate the transmitter or receiver path of a RF-transceiver, the base band device may generate a telegram having a corresponding configuration packet. The configuration packet may include a command for activating the corresponding path. After data is transmitted or received, the base band device may send a further telegram with a configuration packet including a command to switch off the corresponding path again. In addition to the configuration packets, it is often required to transmit an additional time accurate strobe message (TAS-Message) for precise and accurate time synchronization of several RF-transceiver elements. Particularly, in situations wherein, for instance, measurements in adjacent cells are required, transmission of additional packets has to be chosen carefully taking into account the time critical processing.

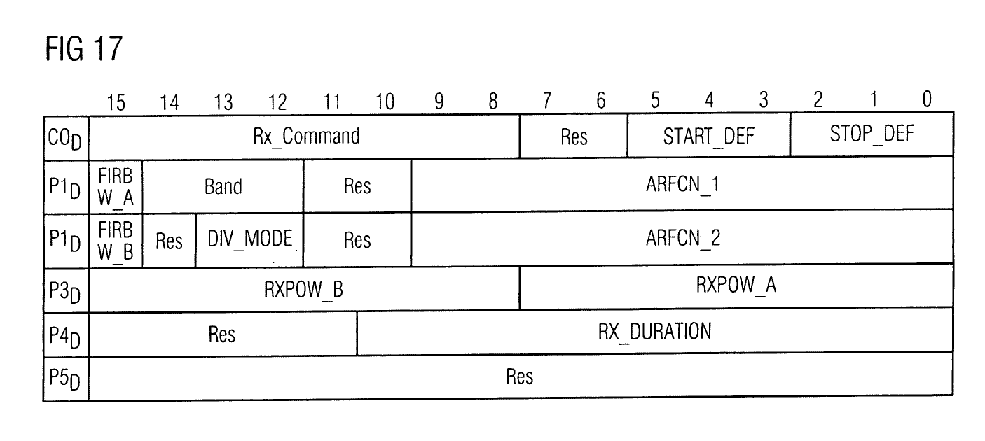

FIG. 17 shows an embodiment of a configuration packet including a parameter indicating a duration for the mode of operation specified by the command Rx_command within the configuration packet. Table TABLE 9 present the parameter used in the configuration packet and a shorter description thereto.

TABLE 9

| Parameter | Description |
|---|---|
| Rx_Command | Macrocommand, requesting a specific |
| | operation mode in a 2^{nd} or 3^{rd} mobile |
| | generation standard |
| StartDef | Specifies the adjustments required to |
| | select the operation mode |
| StopDef | Specifies the operation mode after |
| | expiration of the requested operation |
| | mode (e.g. a reception mode) |
| DIV_MODE | Defines antenna diversity mode specified |
| | in the requested mode |
| FIRBW_A | Adjust the selection filters in the RF- |
| FIRBW_B | transceiver paths according to the |
| | requested mobile generation standard, |
| | second parameter only used in antenna |
| | diversity mode |
| BAND | Specifies the frequency band specified |
| | in the requested mode |
| ARFCN_1 | Specifies the frequency channels within |
| ARFCN_2 | the frequency band set by BAND specified |
| | in the requested mode |
| RXPOW_B | Adjust the gain of amplifiers in the |
| RXPOW_A | receiver path, second parameter used |
| | only in antenna diversity mode |
| RX_DURATION | Specifies the duration of the requested |
| | mode given by a multiplicity of a symbol |
| | duration |
| Res | Reserved (not used) |

In the example, the configuration packet comprises 6 rows with each 16 bits resulting in a configuration packet of totally 96 bits. The first row represents the command row including in bits 15 to 8 the command Rx_command, setting the RF-transceiver to a desired mode of operation. A parameter START_DEF defines an operating state at the beginning of the desired mode of operation set forth by the command Rx_command. Consequently the parameter STOP_DEF gives a definition about the operating state of the RF-transceiver after the duration is expired. In the embodiment, the duration of the mode of operation selected by the command is given by the parameter RX_DURATION. The parameter comprises a length of 11 bits and defines a multiplicity of a symbol duration of a mobile communication standard selected by the command Rx_command and the configuration packet. For example, if a receiver path for a GSM mobile communication standard is to be activated the parameter RX_DURATION may define a multiplicity of the GSM symbol length of 3.69 μsec. Consequently, the receiver path of the RF-transceiver may be switched off after expiration of a time given by RX_DURATION times 3.69 μsec. In case the parameter includes the value 0, the mode of operation is activated until an explicit deactivation command is received by the controller of the RF-receiver.

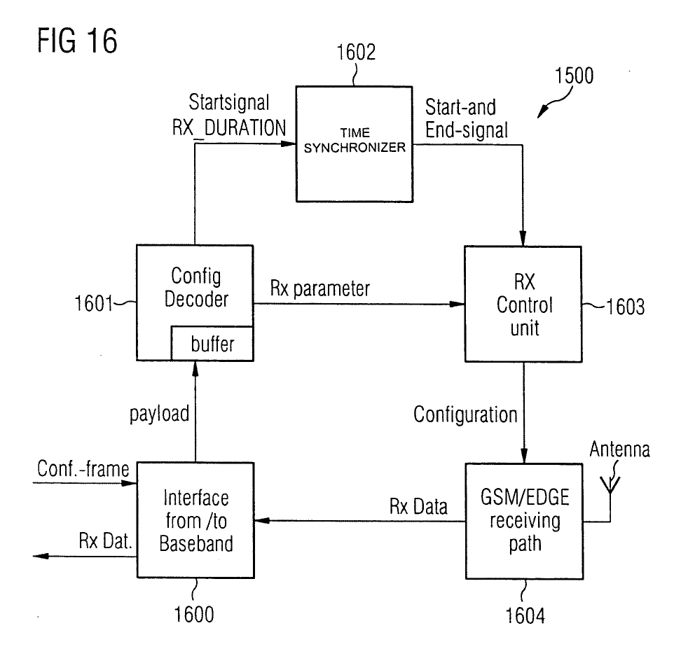

FIG. 16 shows an embodiment for processing a configuration packet according to FIG. 17. A RF-transceiver 1500 comprises an interface 1600 connected to a base band device not shown herein. The interface 1600 is adapted to receive telegrams with configuration and data packets are payload and also transmit telegrams having data packets including received and preprocessed data. The interface 1600 is connected to a command and config decoder 1601 including a buffer, in which parameters not yet used may be buffered. The command and config decoder 1601 processes the payload of the received telegram, receives the command within payload, the parameter RX_DURATION and other parameters.

The other parameters, in this case, Rx parameters are forwarded to the RX control unit 1603. The value in the parameter RX_DURATION is transmitted to a time synchronizer 1602 for providing start and end signals to the RX control unit 1603. Upon reception of a start signal, the RX control unit 1603 provides configuration and adjustments signals to a GSM/EDGE receiving path 1604 in response to the Rx parameters. Any signal received by an antenna is amplified and demodulated in the GSM/EDGE receiving path 1604. The data included in the received signal are sent to the interface 1600 for being transmitted to the base band device.

During reception of a signal and processing the signal in the receiving path, the time synchronizer 1602 measures the expired duration until the value specified by the parameter RX_DURATION is reached. Upon expiration of the duration, an end signal is generated by the time synchronizer and transmitted to the RX control unit 1603. Upon reception of the end-signal, the RX control unit 1603 deactivates the GSM/EDGE receiving path 1604.

If the parameter RX_DURATION comprises the value 0, no end signal by the time synchronizer 1602 is generated. Consequently, the GSM/EDGE receiving path 1604 may continue receive signals via the antenna and provides demodulated data to the interface 1600 until the base band device transmits a new telegram including a stop command in the payload.

The time synchronizer 1602 may comprise a binary counter having a length of at least the length of the parameter RX_DURATION specified in the configuration packet. It may be clocked by a system clock derived and used also for the receiving path in the RF-transceiver.

With the different embodiment disclosed therein a base band device and an RF-transceiver device can exchange data between using a digital interface and a packet-oriented service. Particularly, configuration commands can be sent to the RF-transceiver requesting not only specific operation modes, but also defining a transition between those modes.

The different features of the embodiments shown herein can be combined by one skilled in the art to achieve one or more advantages of the present invention. Although specific embodiments have been illustrated and described, it will be appreciated by one of ordinary skill in the art that any arrangement which is calculated to achieve the same purpose may be substituted for the specific embodiment shown. It is to be understood that the above description is intended to be illustrative and not restrictive. The application is intended to cover any variations of the invention. The scope of the invention includes any other embodiments and applications in which the above structures and methods may be used. The scope of the invention should therefore be determined with reference to the appended claims along with the scope of equivalence to which such claims are entitled.

It is emphasized that the abstract is provided to comply with 37 CFR. Section 1.72(b) requiring an abstract that will allow the reader to quickly ascertain the nature and gist of a technical disclosure. It is submitted with the understanding that it will not be used to interpret or limit the scope of meaning of the claims.

1. A data frame configured for reception and processing by an RF-transceiver, wherein the RF-transceiver comprises a plurality of selectable operating states, wherein some of the plurality of operating states the RF-transceiver is configured to transmit and receive signals according to at least one mobile communication standard,
the data frame comprising:
a command field; and
a parameter field,
wherein the command field comprises a command configured to specify a transition from a first operating state to at least one second subsequent operating state out of the plurality of selectable operating states, and
wherein the parameter field comprises a plurality of parameters configured to define the at least one second subsequent operating state.

2. The data frame of claim 1, wherein the command in the command field is configured to specify at least two transitions between subsequent operating states out of the plurality of selectable operating states.

3. The data frame of claim 1, wherein the parameter field comprises at least one parameter configured to define a duration of the at least one second operating state specified by the command within the command field.

4. The data frame of claim 1, wherein the parameter field comprises at least one parameter configured to define a third operating state after expiration of the at least one second operating state.

5. The data frame of claim 1, wherein the parameter field comprises at least one parameter configured to define the first operating state and at least one parameter defining the at least one second operating state.

6. The data frame of claim 1, wherein the parameter field comprises at least one parameter configured to define the transition between two subsequent operating stages.

7. The data frame of claim 1, wherein the at least one mobile communication standard comprises a frame structure comprising a plurality of time slots, in which signals are to be sent or received, and wherein the parameter field of the data packet comprises parameters concerning the operating state during the time slots.

8. The data frame of claim 1, wherein the plurality of operating states comprises:
transmitting signals according to a mobile communication standard for a predetermined time;
receiving signals according to a mobile communication standard for a predetermined time;
transmitting one or more pulsed signals for a predetermined duration;
receiving one or more pulsed signals for a predetermined duration;
transmitting and receiving one or more pulsed signals for a predetermined duration; and
monitoring a channel determined by a parameter in the parameter field.

9. The data frame of claim 1, wherein the at least one mobile communication standard comprises:
a GSM mobile communication standard;
a GSM/EDGE mobile communication standard;
a 3GPP mobile communication standard;
a 3GPP/FDD mobile communication standard;
a 3GPP/TDD mobile communication standard;
a TD-SCDMA mobile communication standard;
a CDMA2000 mobile communication standard;
a Bluetooth communication standard;
one of 802.11a,b,g,h communication standards;
a LTE mobile communication standard; or
a WiMax communication standard.

10. The data frame of claim 1, further comprising:
a sync field with predefined data content;
a payload field comprising the command field and the parameter field; and
a header field configured to indicate a length of the payload field and a logical channel type of the payload field.

11. A telegram, comprising:
a payload field comprising a first portion and a second portion, and wherein the first portion comprises a macro-code command configured to be processed in an RF-transceiver device and configured to specify at least a first operation mode out of a plurality of operation modes of the RF-transceiver device, and
wherein the second portion comprises a plurality of parameters, wherein at least one first parameter of the plurality of parameters is configured to define a duration for a first operation mode and at least a second parameter of the plurality of parameters is configured to define a condition of the RF-transceiver chip after expiration of the duration.

12. The telegram of claim 11, wherein the telegram has a structure according to the DigRF Dual-Mode 2.5G/3G Baseband/RF IC Interface standard.

13. The telegram of claim 11, wherein the first operation mode comprises a transition of a first mode of operation to a subsequent mode of operation.

14. The telegram of claim 13, wherein the second portion comprises at least a third parameter configured to define the condition of the RF-transceiver during the transition.

15. The telegram of claim 11, wherein the first operation mode comprises at least two transitions between subsequent modes of operation.

16. The telegram of claim 11, wherein the second portion comprises at least one fourth parameter configured to define the at least first operation mode.

17. The telegram of claim 13, wherein the second portion comprises at least a fourth parameter configured to define the first mode of operation and at least a fifth parameter configured to define the subsequent mode of operation.

18. The telegram of claim 11 wherein the second portion comprises at least a parameter defining:
a channel, on which signals are to be transmitted by the RF-transceiver chip;
a channel, on which signals are to be received by the RF-transceiver chip;
a power level indication an estimated power level for a signal to be received;
a diversity mode for the receiver portion of the on which the RF-transceiver chip;
a desired output power for a signal to be transmitted by the transmitter portion of the RF-transceiver chip;
a duration for a bursted signal; or
a signal type for a bursted signal.

19. A method for controlling a RF-transceiver, comprising:
transmitting a telegram, the telegram comprising a command field and a parameter field, the command field comprising a command specifying an operating state of the RF-transceiver or a transition between a first operating state and at least one second operating state of the RF-transceiver, the parameter field comprising a plurality of parameters specifying the operating state or the at least one second operating state;
receiving the telegram by the RF-transceiver;
processing the command within the command field and the plurality of parameters within the parameter field;
transmitting an initializing packet;
receiving said initializing packet by the RF-transceiver;
selecting the operating state as specified in the telegram or switching from the first operating state to the at least one second operating state as specified in the telegram in response to the initializing packet.

20. The method of claim 19, wherein processing the parameter comprises buffering the plurality of parameters in a memory.

21. The method of claim 19, wherein selecting or switching comprises adjusting at least one element of the RF-transceiver in response to at least one parameter of the parameter field.

22. The method of claim 19, further comprising:
selecting an operating state in response to a parameter of the parameter field, the parameter specifying the operation state of the RF-transceiver after expiration of the at least one second operating state.

23. The method of claim 19, wherein the parameter field comprises at least one parameter, the parameter adjusting at least one element of the RF-transceiver after expiration of the at least one second operating state.

24. A communication system, comprising:
an RF-transceiver comprising a plurality of sub-circuits, wherein at least one sub-circuits is adjustable in response to a control signal, and wherein the plurality of sub-circuits are configured to transmit and receive RF-signals, and
a baseband device configured to generate digital baseband signals according at least one mobile communication standard, wherein the RF-transceiver and the baseband device are coupled through a digital interface and each comprise a control circuit, wherein each control circuit is configured to exchange a telegram wherein the telegram comprises:
a payload field comprising a first portion and a second portion, and wherein the first portion comprises a macro-code command configured to be processed in an RF-transceiver device and configured to specify at least a first operation mode out of a plurality of operation modes of the RF-transceiver device, and
wherein the second portion comprises a plurality of parameters, wherein at least one first parameter of the plurality of parameters is configured to define a duration for a first operation mode and at least a second parameter of the plurality of parameters is configured to define a condition of the RF-transceiver chip after expiration of the duration
